(19) United States
(12) Patent Application Publication
(10) Pub. No.: US 2014/0109412 A1
(43) Pub. Date: Apr. 24, 2014

(54) Weed trimmer with collecting bag

(71) Applicant: Charles Raphael Grande, Penn Valley, CA (US)

(72) Inventor: Charles Raphael Grande, Penn Valley, CA (US)

(21) Appl. No.: 14/058,278

(22) Filed: Oct. 20, 2013

Related U.S. Application Data
(60) Provisional application No. 61/795,665, filed on Oct. 22, 2012.

(51) Int. Cl. A01D 43/063

(52) U.S. Cl. CPC A01D 43/0636
USPC 30/124

(57) ABSTRACT

A weed trimmer with collecting bag for cutting and collecting weeds, can include a standard weed trimmer with a cutting implement, and a collecting component, which has a cutting enclosure and a collecting bag. The cutting enclosure covers the cutting implement, which propels the cuttings that are contained and directed by the cutting enclosure, into the collecting bag.

### CROSS-REFERENCE TO RELATED APPLICATIONS

This application claims the benefit of U.S. Provisional Application No. 61/795,665, filed Oct. 22, 2012.

### FIELD OF THE INVENTION

The present invention relates generally to the field of weed trimming devices, and more specifically to weed trimming devices that can collect weed cuttings during use.

### BACKGROUND OF THE INVENTION

A weed trimmer, often also referred to as a string trimmer, weed eater, weed whip, weed cutter, or edge trimmer, works on the principle that a line that is turned fast enough is held out from its housing (the rotating reel) very stiffly by centrifugal force, and can thereby cut grass, weed, and thin branches.

Weed trimmers have become very popular since their invention in the early 1970's. However, it has remained a problem that these devices will shed the cutting remains in the area of operation.

Some attempts have been made to implement container devices for the weed cuttings. Most notably, it has been attempted to combine a weed trimmer with a weed vacuum, so that the trimmings will be collected in the weed vacuum bag. These devices suffer from a number of problems, particularly they can become very heavy, and also they are ineffective because the weed trimmer operation does not work well in conjunction with the inward suction from the vacuum, causing a tendency for a proportion of the cuttings to be pushed to the side instead of into the vacuum bag. As a consequence of these problems, such devices with container bags have not been adopted widely in the market place.

As such, it may be appreciated that there continues to be a need for novel and improved weed trimming devices that can collect weed cuttings during use.

### SUMMARY OF THE INVENTION

The foregoing needs are met, to a great extent, by the present invention, wherein in aspects of this invention, enhancements are provided to the existing models of weed trimmers.

In various aspects of the invention, a standard weed trimmer can be extended with a component that collects weed cuttings during use.

In an aspect of this invention, a weed trimmer with collecting bag can include a standard weed trimmer, which has been extended with a cutting enclosure and a collecting bag, so that weeds are driven from the cutting string or device, directed by the cutting enclosure into the cutting bag.

### BRIEF DESCRIPTION OF THE DRAWINGS

FIG. 1 is a perspective view, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

Throughout this disclosure, a standard weed trimmer shall be defined to include such devices commonly known as string trimmers, weed eaters, weed whips, weed cutters, edge trimmers, etc. A standard weed trimmer has a rotating cutting implement that can cut with a rotating string, metal wire, or other metal or plastic cutting device. These standard weed trimmers do not have any mechanism or function for retaining the grass cuttings. They are typically powered by an internal combustion or electrical engine.

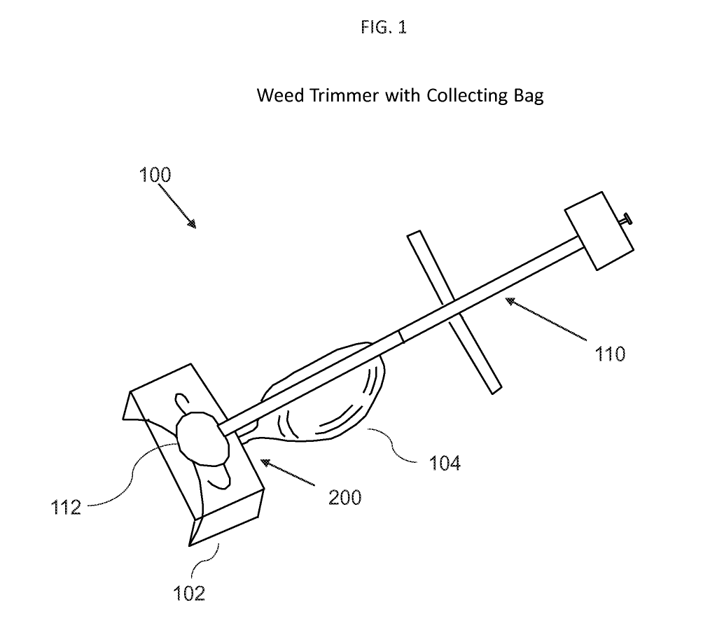

In the following, we describe the structure of an embodiment of a weed trimmer with collecting bag with reference to FIG. 1.

A weed trimmer with collecting bag 100 for cutting and collecting weeds can include:
a. A standard weed trimmer 110, further comprising:
   i. A cutting implement 112;
b. a collecting component 200, further comprising
   i. a cutting enclosure 102, and
   ii. a collecting bag 104.
   wherein the cutting enclosure 102 fits over and covers the cutting implement 112, and the cutting implement 112 propels cuttings, which are contained and directed by the cutting enclosure 102, into the collecting bag 104.

In a related embodiment, the cutting enclosure 102 can be made of a plastic material, or metal, including suitable alloys, each respectively of a suitable thickness and strength.

In a related embodiment, the collecting bag 104 can be made of a fabric or a plastic material, each respectively of a suitable flexibility, thickness, and strength.

Here has thus been described embodiments of the weed trimmer with collecting bag device, and methods related thereto, which can be employed in numerous modes of usage.

The many features and advantages of the multitude of embodiments of the weed trimmer with collecting bag are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A weed trimmer with collecting bag for cutting and collecting weeds comprising:
a. a standard weed trimmer, further comprising:
i. a cutting implement;
b. a collecting component, further comprising:
i. a cutting enclosure, and
ii. a collecting bag;
wherein the cutting enclosure fits over and covers the cutting implement, and the cutting implement propels cuttings, which are contained and directed by the cutting enclosure, into the collecting bag.

2. The weed trimmer of claim 1, wherein the cutting enclosure is made of a plastic material.

3. The weed trimmer of claim 1, wherein the cutting enclosure is made of a metal.

4. The weed trimmer of claim 1, wherein the collecting bag is made of a fabric material.

5. The weed trimmer of claim 1, wherein the collecting bag is made of a plastic material.
